(19) United States
(12) Patent Application Publication
(10) Pub. No.: US 2006/0189769 A1
(43) Pub. Date: Aug. 24, 2006

(54) Broad/bimodal resins with controlled comonomer distribution

(75) Inventors: Peter Phung Minh Hoang, Calgary (CA); Gail Baxter, Calgary (CA)

Correspondence Address: KENNETH H. JOHNSON, P.O. BOX 630708, HOUSTON, TX, 77263, US

(73) Assignee: NOVA Chemicals (International) S.A.

(21) Appl. No.: 11/064,293

(22) Filed: Feb. 22, 2005

(51) Int. Cl. C08F 4/44

(52) U.S. Cl. 526/129; 526/160; 526/943; 526/901

(57) ABSTRACT

Olefin polymers having a conventional comonomer incorporation, a reverse (or partial reverse) comonomer incorporation or a substantially flat comonomer incorporation with a broad, bimodal or multimodal molecular weight distribution are produced under a process using a single site catalyst with the combination of a phosphinimine and/or ketimide compound, and an aluminum compound in a cyclical controlled increase of the ratio of hydrogen to ethylene and controlled or uncontrolled decrease of the ratio of hydrogen to ethylene if plotted as a function of time.

### FIELD OF THE INVENTION

The present invention relates to a process for producing olefin polymers having a broad or bimodal molecular weight distribution. Further the olefin polymers may have a regular comonomer distribution (e.g. the comonomer incorporation decreases with increasing molecular weight), relatively uniform comonomer distribution over all or substantially all molecular weight or a reverse comonomer distribution (e.g. increasing comonomer incorporation with increasing molecular weight) or rising and then a flat distribution or a rising and falling comonomer incorporation. More particularly the present invention relates to processes to produce such polymers using a single site catalyst which generally tend to produce polymers having a narrow molecular weight distribution.

### BACKGROUND OF THE INVENTION

U.S. Pat. No. 5,739,220 issued Apr. 14, 1998 and U.S. Pat. No. 6,156,854 issued Dec. 5, 2000 to Shamshoum et al., assigned to Fina Technology Inc. teach a process in which a polyolefin such as polyethylene having a broader molecular weight distribution is produced in the presence of a catalyst comprising a metallocene or a metallocene component by spiking the reaction with hydrogen so there is a reaction period where the reactants are relatively hydrogen rich and letting the hydrogen be consumed so there is a period where the reactants are relatively hydrogen lean. This may be repeated a number of times. The patent does not teach the use of the catalysts of the present invention.

WO 99/03897 published Jan. 28, 1999 assigned to Borealis A/S teaches a process for producing a polymer having a desirable molecular weight distribution. The patent teaches a catalyst comprising a conventional metallocene catalysts in the presence of controlled amounts of hydrogen. The patent fails to teach a catalyst comprising a phosphinimine or ketimide ligand.

WO 99/65949 published Dec. 23, 1999 assigned to Borealis A/S teaches a process for producing a polymer having a desirable molecular weight distribution. The patent teaches a catalyst comprising a conventional metallocene catalysts in the presence of controlled amounts of hydrogen. The patent fails to teach a catalyst comprising a phosphinimine or ketimide ligand.

The present invention seeks to provide an additional process to make broader molecular weight polymers or bimodal polymers in one reactor.

### SUMMARY OF THE INVENTION

The present invention provides a process to produce a copolymer comprising 60 to 99 weight % of ethylene and from 1 to 40 weight % of one or more C₃₋₈ alpha olefins having a Mw/Mn greater than 3 comprising polymerizing a mixture of monomers comprising 60 to 99 weight % of ethylene and from 1 to 40 weight % of one or more C₃₋₈ alpha olefins in the presence of a catalyst comprising a catalyst of the formula 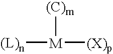
wherein M is a transition metal; C is a bulky heteroatom ligand selected from the group consisting of phosphinimine ligands and ketimide ligands; L is a monoanionic ligand selected from the group consisting of a cyclopentadienyl-type ligand and a bulky heteroatom ligand other than an phosphinimine ligand and a ketimide ligand; X is an activatable ligand; m is 1 or 2; n is 0 or 1; and p is an integer and the sum of m+n+p equals the valence state of M, provided that when m is 2, C may be the same or different bulky heteroatom ligands, and a cocatalyst and cyclically increasing by at least 5% (by pressure) and then decreasing the ratio of hydrogen to ethylene

### BRIEF DESCRIPTION OF THE DRAWINGS

FIG. 1 shows GPC plots of resins produced in Examples 1a to 1c.

FIG. 2 shows the Mw distribution and comonomer distribution profiles of the resin of Example 2a.

FIG. 3 shows the Mw distribution and comonomer distribution profiles of the resin of Example 2b.

### BEST MODE

The catalysts of the present invention have the formula: 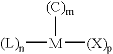
wherein M is a transition metal selected from the group consisting of Ti, Hf and Zr (as described below); C is a bulky heteroatom ligand selected from the group consisting of phosphinimine ligands (as described below) and ketimide ligands (as described below); L is a monoanionic ligand selected from the group consisting of a cyclopentadienyl-type ligand and a bulky heteroatom ligand other than an phosphinimine ligand and a ketimide ligand; X is an activatable ligand; m is 1 or 2; n is 0 or 1; and p is an integer and the sum of m+n+p equals the valence state of M, provided that when m is 2, C may be the same or different bulky heteroatom ligands.

For example, the catalyst may be a bis(phosphinimine), a bis (ketimide), or a mixed phosphinimine ketimide dichloride complex of titanium, zirconium or hafnium. Alternately, the catalyst contains one phosphinimine ligand or one ketimide ligand, one “L” ligand (which is most preferably a cyclopentadienyl-type ligand) and two “X” ligands (which are preferably both chloride).

The preferred metals (M) are from Group 4 (especially titanium, hafnium or zirconium) with titanium being most preferred. In one embodiment the catalysts are group 4 metal complexes in the highest oxidation state.

The catalyst may contain one or two phosphinimine ligands (P1) which are bonded to the metal. The phosphinimine ligand is defined by the formula: 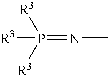
wherein each R³ is independently selected from the group consisting of a hydrogen atom; a halogen atom; C₁₋₂₀, preferably C₁₋₁₀ hydrocarbyl radicals which are unsubstituted by or further substituted by a halogen atom; a C₁₋₈ alkoxy radical; a C₆₋₁₀ aryl or aryloxy radical; an amido radical; a silyl radical of the formula:
—Si—(R²)₃
wherein each R² is independently selected from the group consisting of hydrogen, a C₁₋₈ alkyl or alkoxy radical, and C₆₋₁₀ aryl or aryloxy radicals; and a germanyl radical of the formula:
—Ge—(R²)₃
wherein R² is as defined above.

The preferred phosphinimines are those in which each R³ is a hydrocarbyl radical, preferably a C₁₋₆ hydrocarbyl radical.

Suitable phosphinimine catalysts are Group 4 organometallic complexes which contain one phosphinimine ligand (as described above) and one ligand L which is either a cyclopentadienyl-type ligand or a heteroatom ligand.

As used herein, the term “ketimide ligand” refers to a ligand which:

(a) is bonded to the transition metal via a metal-nitrogen atom bond;

(b) has a single substituent on the nitrogen atom (where this single substituent is a carbon atom which is doubly bonded to the N atom); and

(c) has two substituents Sub 1 and Sub 2 (described below) which are bonded to the carbon atom.

Conditions a, b and c are illustrated below:

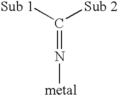

The substituents “Sub 1” and “Sub 2” may be the same or different. Exemplary substituents include hydrocarbyls having from 1 to 20, preferably from 3 to 6, carbon atoms, silyl groups (as described below), amido groups (as described below) and phosphido groups (as described below). For reasons of cost and convenience it is preferred that these substituents both be hydrocarbyls, especially simple alkyls and most preferably tertiary butyl.

Suitable ketimide catalysts are Group 4 organometallic complexes which contain one ketimide ligand (as described above) and one ligand L which is either a cyclopentadienyl-type ligand or a heteroatom ligand.

Cyclopentadienyl-type ligands include unsubstituted cyclopentadienyl, substituted cyclopentadienyl, unsubstituted indenyl, substituted indenyl, unsubstituted fluorenyl and substituted fluorenyl. An exemplary list of substituents for a cyclopentadienyl-type ligand includes the group consisting of C₁₋₁₀ hydrocarbyl radicals (including phenyl and benzyl radicals), which hydrocarbyl substituents are unsubstituted or further substituted by one or more substituents selected from the group consisting of a halogen atom, preferably a chlorine or fluorine atom and a C₁₋₄ alkyl radical; a C₁₋₈ alkoxy radical; a C₆₋₁₀ aryl or aryloxy radical; an amido radical which is unsubstituted or substituted by up to two C₁₋₈ alkyl radicals; a phosphido radical which is unsubstituted or substituted by up to two C₁₋₈ alkyl radicals; silyl radicals of the formula —Si—(R)₃ wherein each R is independently selected from the group consisting of hydrogen, a C₁₋₈ alkyl or alkoxy radical, and C₆₋₁₀ aryl or aryloxy radicals; and germanyl radicals of the formula —Ge—(R)₃ wherein R is as defined directly above.

Preferably the cyclopentadienyl-type ligand selected from the group consisting of a cyclopentadienyl radical, an indenyl radical and a fluorenyl radical which are unsubstituted or up to fully substituted by one or more substituents selected from the group consisting of a fluorine atom, a chlorine atom; C₁₋₄ alkyl radicals; and a phenyl or benzyl radical which is unsubstituted or substituted by one or more fluorine or chlorine atoms.

As used herein, the term “heteroatom ligand” refers to a ligand which contains at least one heteroatom selected from the group consisting of boron, nitrogen, oxygen, phosphorus or sulfur. The heteroatom ligand may be sigma or pi-bonded to the metal. Exemplary heteroatom ligands include silicon-containing heteroatom ligands, amido ligands, alkoxy ligands, boron heterocyclic ligands and phosphole ligands, as all described below.

Silicon containing heteroatom ligands are defined by the formula:
—(Y)SiRₓR_{y}R_{z}
wherein the — denotes a bond to the transition metal and Y is sulfur or oxygen.

The substituents on the Si atom, namely Rₓ, R_{y} and R_{z} are required in order to satisfy the bonding orbital of the Si atom. The use of any particular substituent Rₓ, R_{y} or R_{z} is not especially important to the success of this invention. It is preferred that each of Rₓ, R_{y} and R_{z} is a C₁₋₂ hydrocarbyl group (i.e. methyl or ethyl) simply because such materials are readily synthesized from commercially available materials.

The term “amido” is meant to convey its broad, conventional meaning. Thus, these ligands are characterized by (a) a metal-nitrogen bond; and (b) the presence of two substituents (which are typically simple alkyl or silyl groups) on the nitrogen atom.

The terms “alkoxy” and “aryloxy” is also intended to convey its conventional meaning. Thus, these ligands are characterized by (a) a metal oxygen bond; and (b) the presence of a hydrocarbyl group bonded to the oxygen atom. The hydrocarbyl group may be a C₁₋₁₀ straight chained, branched or cyclic alkyl radical or a C₆₋₁₃ aromatic radical which radicals are unsubstituted or further substituted by one or more C₁₋₄ alkyl radicals (e.g. 2,6 di-tertiary butyl phenoxy).

Boron heterocyclic ligands are characterized by the presence of a boron atom in a closed ring ligand. This definition includes heterocyclic ligands which also contain a nitrogen atom in the ring. These ligands are well known to those skilled in the art of olefin polymerization and are fully described in the literature (see, for example, U.S. Pat. Nos. 5,637,659; 5,554,775; and the references cited therein).

The term “phosphole” is also meant to convey its conventional meaning. “Phospholes” are cyclic dienyl structures having four carbon atoms and one phosphorus atom in the closed ring. The simplest phosphole is C₄H₄ (which is analogous to cyclopentadiene with one carbon in the ring being replaced by phosphorus). The phosphole ligands may be substituted with, for example, C₁₋₂₀ hydrocarbyl radicals (which may, optionally, contain halogen substituents); phosphido radicals; amido radicals; or silyl or alkoxy radicals. Phosphole ligands are also well known to those skilled in the art of olefin polymerization and are described as such in U.S. Pat. No. 5,434,116 (Sone, to Tosoh).

The term “activatable ligand” or “leaving ligand” refers to a ligand which may be activated by the aluminoxane (also referred to as an “activator”) to facilitate olefin polymerization. Exemplary activatable ligands are independently selected from the group consisting of a hydrogen atom; a halogen atom, preferably a chlorine or fluorine atom; a C₁₋₁₀ hydrocarbyl radical, preferably a C₁₋₄ alkyl radical; a C₁₋₁₀ alkoxy radical, preferably a C₁₋₄ alkoxy radical; and a C₅₋₁₀ aryl oxide radical; each of which said hydrocarbyl, alkoxy, and aryl oxide radicals may be unsubstituted by or further substituted by one or more substituents selected from the group consisting of a halogen atom, preferably a chlorine or fluorine atom; a C₁₋₈ alkyl radical, preferably a C₁₋₄ alkyl radical; a C₁₋₈ alkoxy radical, preferably a C₁₋₄ alkoxy radical; a C₆₋₁₀ aryl or aryloxy radical; an amido radical which is unsubstituted or substituted by up to two C₁₋₈, preferably C₁₋₄ alkyl radicals; and a phosphido radical which is unsubstituted or substituted by up to two C₁₋₈, preferably C₁₋₄ alkyl radicals.

The number of activatable ligands depends upon the valency of the metal and the valency of the activatable ligand. The preferred catalyst metals are Group 4 metals in their highest oxidation state (i.e. 4⁺) and the preferred activatable ligands are monoanionic (such as a halide—especially chloride or C₁₋₄ alkyl—especially methyl). One useful group of catalysts contain a phosphinimine ligand, a cyclopentadienyl ligand and two chloride (or methyl) ligands bonded to the Group 4 metal. In some instances, the metal of the catalyst component may not be in the highest oxidation state. For example, a titanium (III) component would contain only one activatable ligand.

As noted above, one group of catalysts is a Group 4 organometallic complex in its highest oxidation state having a phosphinimine ligand, a cyclopentadienyl-type ligand and two activatable ligands. These requirements may be concisely illustrated using the following formula for the phosphinimine catalyst: 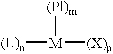
wherein: M is a metal selected from Ti, Hf and Zr; P1 is as defined above, but preferably a phosphinimine wherein R³ is a C₁₋₆ alkyl radical, most preferably a t-butyl radical; L is a ligand selected from the group consisting of cyclopentadienyl, indenyl and fluorenyl ligands which are unsubstituted or substituted by one or more substituents selected from the group consisting of a halogen atom, preferably chlorine or fluorine; C₁₋₄ alkyl radicals; and benzyl and phenyl radicals which are unsubstituted or substituted by one or more halogen atoms, preferably fluorine; X is selected from the group consisting of a chlorine atom and C₁₋₄ alkyl radicals; m is 1; n is 1; and p is 2.

In one embodiment of the present invention the transition metal complex may have the formula: [(Cp)ₙM[N═P(R³)]ₘXₚ wherein M is the transition metal; Cp is a C₅₋₁₃ ligand containing a 5-membered carbon ring having delocalized bonding within the ring and bound to the metal atom through covalent η⁵ bonds and said ligand being unsubstituted or up to fully substituted with one or more substituents selected from the group consisting of a halogen atom, preferably chlorine or fluorine; C₁₋₄ alkyl radicals; and benzyl and phenyl radicals which are unsubstituted or substituted by one or more halogen atoms, preferably fluorine; R³ is a substituent selected from the group consisting of C₁₋₆ straight chained or branched alkyl radicals, C₆₋₁₀ aryl and aryloxy radicals which are unsubstituted or may be substituted by up to three C₁₋₄ alkyl radicals, and silyl radicals of the formula —Si—(R)₃ wherein R is C₁₋₄ alkyl radical or a phenyl radical; L is selected from the group consisting of a leaving ligand; n is 1 or 2; m is 1 or 2; and the valence of the transition metal—(q+b)=p. In these complexes the CPN bond angle is less than 108.50, preferably less than 108.0°.

Typically the activator may be selected from the group consisting of:

(i) a complex aluminum compound of the formula R¹²₂AlO(R²AlO)ₘAlR¹²₂ wherein each R¹² is independently selected from the group consisting of C₁₋₂₀ hydrocarbyl radicals and m is from 3 to 50.

(ii) ionic activators selected from the group consisting of:
(A) compounds of the formula [R¹³]⁺[B(R⁴)₄]⁻ wherein B is a boron atom, R¹³ is a methyl cation which is substituted by three C₅₋₇ aromatic hydrocarbons and each R⁴ is independently selected from the group consisting of phenyl radicals which are unsubstituted or substituted with 3 to 5 substituents selected from the group consisting of a fluorine atom, a C₁₋₄ alkyl or alkoxy radical which is unsubstituted or substituted by a fluorine atom; and a silyl radical of the formula —Si—(R⁵)₃; wherein each R⁵ is independently selected from the group consisting of a hydrogen atom and a C₁₋₄ alkyl radical; and
(B) compounds of the formula [(R⁸)ₜZH]⁺[B(R⁴)₄]⁻ wherein B is a boron atom, H is a hydrogen atom, Z is a nitrogen atom or phosphorus atom, t is 2 or 3 and R⁸ is selected from the group consisting of C₁₋₈ alkyl radicals, a phenyl radical which is unsubstituted or substituted by up to three C₁₋₄ alkyl radicals, or one R⁸ taken together with the nitrogen atom may form an anilinium radical and R⁴ is as defined above; and
(C) compounds of the formula B(R⁴)₃ wherein R⁴ is as defined above; and

(iii) mixtures of (i) and (ii).

In the aluminum compound preferably, R¹² is a methyl radical and m is from 10 to 40.

The catalysts systems in accordance with the present invention may have a molar ratio of aluminum from the aluminoxane to transition metal from 5:1 to 1000:1, preferably from 5:1 to 300:1, most preferably from 30:1 to 300:1, most desirably from 50:1 to 120:1.

The “ionic activator” may abstract one activatable ligand so as to ionize the catalyst center into a cation, but not to covalently bond with the catalyst and to provide sufficient distance between the catalyst and the ionizing activator to permit a polymerizable olefin to enter the resulting active site.

Examples of ionic activators include:
triethylammonium tetra(phenyl)boron,
tripropylammonium tetra(phenyl)boron,
tri(n-butyl)ammonium tetra(phenyl)boron,
trimethylammonium tetra(p-tolyl)boron,
trimethylammonium tetra(o-tolyl)boron,
tributylammonium tetra(pentafluorophenyl)boron,
tripropylammonium tetra(o,p-dimethylphenyl)boron,
tributylammonium tetra(m,m-dimethylphenyl)boron,
tributylammonium tetra(p-trifluoromethylphenyl)boron,
tributylammonium tetra(pentafluorophenyl)boron,
tri(n-butyl)ammonium tetra(o-tolyl)boron,
N,N-dimethylanilinium tetra(phenyl)boron,
N,N-diethylanilinium tetra(phenyl)boron,
N,N-diethylanilinium tetra(phenyl)n-butylboron,
di-(isopropyl)ammonium tetra(pentafluorophenyl)boron,
dicyclohexylammonium tetra(phenyl)boron,
triphenylphosphonium tetra(phenyl)boron,
tri(methylphenyl)phosphonium tetra(phenyl)boron,
tri(dimethylphenyl)phosphonium tetra(phenyl)boron,
tropillium tetrakispentafluorophenyl borate,
triphenylmethylium tetrakispentafluorophenyl borate,
tropillium phenyltrispentafluorophenyl borate,
triphenylmethylium phenyltrispentafluorophenyl borate,
benzene (diazonium)phenyltrispentafluorophenyl borate,
tropillium tetrakis(2,3,5,6-tetrafluorophenyl)borate,
triphenylmethylium tetrakis(2,3,5,6-tetrafluorophenyl)borate,
tropillium tetrakis(3,4,5-trifluorophenyl)borate,
benzene(diazonium)tetrakis(3,4,5-trifluorophenyl)borate,
tropillium tetrakis(1,2,2-trifluoroethenyl)borate,
triphenylmethylium tetrakis(1,2,2-trifluoroethenyl)borate,
tropillium tetrakis(2,3,4,5-tetrafluorophenyl)borate, and
triphenylmethylium tetrakis(2,3,4,5-tetrafluorophenyl)borate.

Readily commercially available ionic activators include:
N,N-dimethylaniliniumtetrakispentafluorophenyl borate;
triphenylmethylium tetrakispentafluorophenyl borate(tritylborate); and
trispentafluorophenyl borane.

If the phosphinimine compound is activated only with the ionic activator the molar ratio of transition metal to boron will be from 1:1 to 1:3 preferably from 1:1.05 to 1:1.20.

In a preferred embodiment of the present invention the catalyst is a combination of a phosphinimine or ketimide compound and an aluminum compound. Generally such a catalyst system has a molar ratio of transition metal (e.g. Ti):AI from 1:20 to 1:120, preferably 1:30 to 1:80.

Generally in the process of the present invention the ratio of hydrogen to ethylene is increased from 5 up to 500% by pressure over a period of time less than 5 minutes and then the ratio of hydrogen to ethylene declines with the polymerization for a period from 5 to 60 minutes before the next increase. Preferably the ratio of hydrogen to ethylene is increased in a period of time of less than 1 minute. The cyclical controlled increase of the ratio of hydrogen to ethylene and controlled or uncontrolled (e.g. consumption of hydrogen by the reaction) decrease of the ratio of hydrogen to ethylene if plotted as a function of time would form a curve selected from the group consisting of sine curves, sharp spike curve, and either a symmetrical or unsymmetrical triangular wave, and a square wave.

For slurry and gas phase polymerization, and optionally for solution phases polymerization, the catalyst systems of the present invention may further be supported on a refractory support or an organic support (including polymeric support as for example disclosed in U.S. Pat. No. 6,583,082 B2 issued Jun. 24, 2003 in the name of Hoang et al., assigned to the Governors of the University of Alberta). That is, either the transition metal complex, the aluminoxane compound, the ionic activator or a mixture thereof may be supported on a refractory support or an organic support (e.g. polymeric). Some refractories include silica which may be treated to reduce surface hydroxyl groups and alumina, preferably silica. The support or carrier may be a spray-dried silica. Generally the support will have an average particle size from about 0.1 to about 1000, preferably from about 10 to 150 microns. The support typically will have a surface area of at least about 50 m²/g, preferably from about 150 to 1500 m²/g. The pore volume of the support should be at least 0.2, preferably greater than 0.6 cm³/g.

If the support is silica it may be dried by heating at a temperature of at least about 100° C., for at least 2 hours, preferably from about 2 to 24 hours under an inert atmosphere. In an alternate treatment, the excess surface hydroxyl radicals may be removed by chemical reaction with a reactive species. Suitable reactive species include metal alkyls, including magnesium alkyls, lithium alkyls and aluminum alkyls.

In supporting the aluminoxane, ionic activator, catalyst or mixture thereof on the support, conventional techniques may be used. The support in a hydrocarbyl diluent may be contacted with the aluminoxane, ionic activator, the catalyst or a mixture thereof in the same or a compatible hydrocarbyl solvent or diluent. The resulting treated support may be separated from the bulk of the solvent or diluent by decanting or by drying typically from room temperature (20° C.) to about 60° C., preferably under vacuum (of less than about 10 torr) optionally while passing an inert gas such as nitrogen through the separated support and diluent/solvent. It should be noted that if polymeric supports are used they may swell in the solvent or diluent but should not readily dissolve if the polymer is crosslinked. It may be possible to spray dry the polymeric support together with the aluminoxane, ionic activator catalyst, or a mixture thereof.

Inert hydrocarbon solvents typically comprise a C₄₋₁₂ hydrocarbon which may be unsubstituted or substituted by a C₁₋₄ alkyl group, such as butane, pentane, hexane, heptane, octane, cyclohexane, methylcyclohexane or hydrogenated naphtha. An alternative solvent is Isopar E (C₈₋₁₂ aliphatic solvent, Exxon Chemical Co.).

Solution and slurry polymerization processes are fairly well known in the art. These processes are conducted in the presence of an inert hydrocarbon solvent such as those listed above.

The polymerization may be conducted at temperatures from about 20° C. to about 250° C. Depending on the product being made, this temperature may be relatively low such as from 20° C. to about 180° C., typically from about 80° C. to 150° C. and the polymer is insoluble in the liquid hydrocarbon phase (diluent) (e.g. a slurry polymerization). The reaction temperature may be relatively higher from about 180° C. to 250° C., preferably from about 180° C. to 230° C. and the polymer is soluble in the liquid hydrocarbon phase (solvent). The pressure of the reaction may be as high as about 15,000 psig for the older high pressure processes or may range from about 15 to 4,500 psig.

In the gas phase polymerization of a gaseous mixture comprising from 0 to 15 mole % of hydrogen, from 0 to 30 mole % of one or more C₃₋₈ alpha-olefins, from 15 to 100 mole % of ethylene, and from 0 to 75 mole % of an inert gas at a temperature from 50° C. to 120° C., preferably from 75° C. to about 110° C., and at pressures typically not exceeding 3447 kPa (about 500 psi), preferably not greater than 2414 kPa (about 350 psi).

Suitable olefin monomers include ethylene and C₃₋₁₀ alpha olefins which are unsubstituted or substituted by up to two C₁₋₆ alkyl radicals. Illustrative non-limiting examples of such alpha olefins are one or more of propylene, 1-butene, 1-pentene, 1-hexene, 1-heptene, 1-octene and 1-decene. The polymers prepared in accordance with the present invention have a wide range of molecular weight distribution (Mw/Mn or polydispersity). The molecular weight distribution may be controlled from about 2.5 to about 30, typically the polydispersity is above 3 and a useful polydispersity is from about from 5 to about 25.

The polyethylene polymers which may be prepared in accordance with the present invention typically comprise not less than 60, preferably not less than 70, most preferably not less than 80 weight % of ethylene and the balance of one or more C₃₋₁₀ alpha olefins, preferably selected from the group consisting of 1-butene, 1-hexene and 1-octene.

The polymers prepared in accordance with the present invention may have a conventional comonomer incorporation, a reverse (or partial reverse) comonomer incorporation or a substantially flat comonomer incorporation. The phrase reverse or partial reverse comonomer incorporation means that on deconvolution of the GPC-FTIR (or TREF) data (profiles) (typically using molecular weight distribution segments of not less than 10,000) there is one or more higher molecular component having a higher comonomer incorporation than the comonomer incorporation in one or more lower molecular segments. If the comonomer incorporation is rising with molecular weight the distribution would be reverse. However the comonomer incorporation may rise with increasing molecular weight then decline in which case the comonomer distribution would be partially reverse (or partially regular).

The polymer may be compounded with conventional heat and light stabilizers (antioxidants) and UV stabilizers in conventional amounts. Typically the antioxidant may comprise a hindered phenol and a secondary antioxidant generally in a weight ratio of about 0.5:1 to 5:1 and the total amount of antioxidant may be from 200 to 3,000 ppm. Generally, the UV stabilizer may be used in amounts from 100 to 1,000 ppm.

The present invention will now be illustrated by the following non-limiting examples. In the examples unless otherwise indicated parts means part by weight (i.e. grams) and percent means weight percent.

### EXAMPLES

Experimental

In the experiments the following abbreviations were used:

THF=tetrahydrofuran

TMS=trimethyl silyl

Molecular weight distribution and molecular weight averages (Mw, Mn, Mz) of resins were determined using high temperature Gel Permeation Chromatography (GPC) according to the ASTM D6474: “Standard Test Method for Determining Molecular Weight Distribution and Molecular Weight Averages of Polyolefins”. The system was calibrated using the 16 polystyrene standards (Mw/Mn<1.1) in Mw range 5×10³ to 8×10⁶ and 3 hydrocarbon Standards C₆₀, C₄₀, and C₂₀.

The operating conditions are listed below:
GPC instrument: Polymer Laboratories® 220 equipped with a refractive index detector
Software: Viscotek® DM 400 Data Manager with Trisec® software
Columns: 4 Shodex® AT-800/S series cross-linked styrene-divinylbenzene with pore sizes 10³ Å, 10⁴ Å, 10⁵ Å, 10⁶ Å
Mobile Phase: 1,2,4-trichlorobenzene
Temperature: 140° C.
Flow Rate: 1.0 ml/min
Sample Preparation: Samples were dissolved in 1,2,4-trichloro-benzene by heating on a rotating wheel for four hours at 150° C.
Sample Filtration: No
Sample Concentration: 0.1% (w/v)

The determination of branch frequency as a function of molecular weight was carried out using high temperature Gel Permeation Chromatography (GPC) and FT-IR of the eluent. Polyethylene standards with a known branch content, polystyrene and hydrocarbons with a known molecular weight were used for calibration.

Operating conditions are listed below:
GPC instrument: Waters® 150 equipped with a refractive index detector
IR Instrument: Nicolet Magna® 750 with a Polymer Labs® flow cell.
Software: Omnic® 5.1 FT-IR
Columns: 4 Shodex® AT-800/S series cross-linked styrene-divinylbenzene with pore sizes 10³ Å, 10⁴ Å, 10⁵ Å, 10⁶ Å
Mobile Phase: 1,2,4-Trichlorobenzene
Temperature: 140° C.
Flow Rate: 1.0 ml/min
Sample Preparation: Samples were dissolved in 1,2,4-trichlorobenzene by heating on a rotating wheel for five hours at 150° C.
Sample Filtration: No
Sample Concentration: 4 mg/g

### Synthesis of (tBu₃PN)(n-BuCPC₆F₅)Cl₂

Sodium cyclopentadiene (615 mmol) was dissolved in THF and a solution of perfluorobenzene (309 mmol) was added as a 1:1 solution with THF over a 20 minute period. The resulting mixture was allowed to cool for 3 hours at 60° C., then added by cannula transfer to neat chlorotrimethylsilane (60 mL) at 0° C. over 15 minutes. The reaction was allowed to warm to ambient temperature for 30 minutes, followed by slow concentration over a 3 hour period to remove excess chlorotrimethylsilane and solvents. The resulting wet solid was slurried in heptane and filtered. Concentration of the heptane filtrate gave crude (TMS)(C₆F₅)C₅H₄ as a brown oil which was used without further purification. (TMS)(C₆F₅)C₅H₄ (50 mmol) was dissolved in THF and cooled to 0° C. The solution was treated with n-BuLi (50 mmol), which was added dropwise. After stirring for 10 minutes at 0° C., the reaction was allowed to warm to ambient temperature and stirred for a further 1 hour. A cold solution of n-butyl bromide (50 mmol) was prepared in THF (35 mL), and to this was added the [(TMS)(C₆F₅)C₅H₃]Li solution. The resulting mixture was stirred for 2 hours and the THF was removed by evaporation under vacuum. The residue was extracted into heptane (150 mL), filtered and the solvent was evaporated. TiCl₄ (60 mmol) was added to the (n-Bu)(TMS)(C₆F₅)C₅H₃ via pipette and the solution was heated to 60° C. for 3 hours. Removal of excess TiCl₄ under vacuum gave a thick oil. Addition of pentane caused immediate precipitation of product ((nBu)(C₆F₅)C₅H₃)TiCl₃ which was isolated by filtration. ((nBu)(C₆F₅)C₅H₃)TiCl₃ (15.6 mmol) was mixed with (tBu)₃PN-TMS (15.6 mmol) in toluene and stirred overnight at ambient temperature. The solution was filtered and the solvent removed to give desired product.

Preparation of Silica-Supported Aluminoxane (MAO)

Sylopol XPO-2408 silica purchased from Grace Davison was calcined by fluidizing with air at 200° C. for 2 hours and subsequently with nitrogen at 600° C. for 6 hours. 44.6 grams of the calcined silica was added in 100 mL of toluene. 150.7 g of a MAO solution containing 4.5 weight % Al purchased from Albemarle was added to the silica slurry. The mixture was stirred for 1 hour at ambient temperature. The solvent was removed by vacuum, yielding a free flowing solid containing 11.5 weight % Al.

Preparation of Supported Catalyst:

In a glovebox, 1.96 grams of silica-supported MAO prepared above was slurried in 20 mL of toluene. Separately, 44 mg of (tBu₃PN)(C₆F₅)(n-Bu)CpTiCl₂ was dissolved in 10 mL of toluene and added to the silica slurry. After one hour of stirring, the slurry was filtered, yielding a clear filtrate. The solid component was washed twice with toluene, and once with heptane. The final product was dried in vacuo to 300 mTorr (40 Pa) and stored under nitrogen until use.

Polymerization

### Example 1a

A 2 L stirred Parr reactor was heated at 100° C. for 1 hour and thoroughly purged with argon. The reactor was then cooled to 40° C. 910 mL of n-hexane, 30 mL of 1-hexene and 0.6 mL of a 25.5 weight % of triiso-butyl aluminum (TiBAL) in hexanes were added to the reactor. The reactor was then heated to 70° C. Hydrogen from a 150 mL cylinder was added to the reactor such that the pressure drop in the hydrogen cylinder was 30 psia. The reactor was then pressurized with 140 psig ethylene. Argon was used to push 26.2 mg of the supported catalyst prepared above from a tubing into the reactor to start the reaction. During the polymerization, the reactor pressure was maintained constant with 104 psig of ethylene. The polymerization was carried out for 10 minutes, yielding 25.2 g of polymer.

### Example 1b

The polymerization was the same as Example 1a, except that 27.7 mg of the supported catalyst was used and the polymerization was performed for 30 minutes, yielding 61.8 g of polymer.

### Example 1c

The polymerization was the same as Example 1a, except that 28.4 mg of the supported catalyst was used and the polymerization was performed for 60 minutes, yielding 108.4 g of polymer.

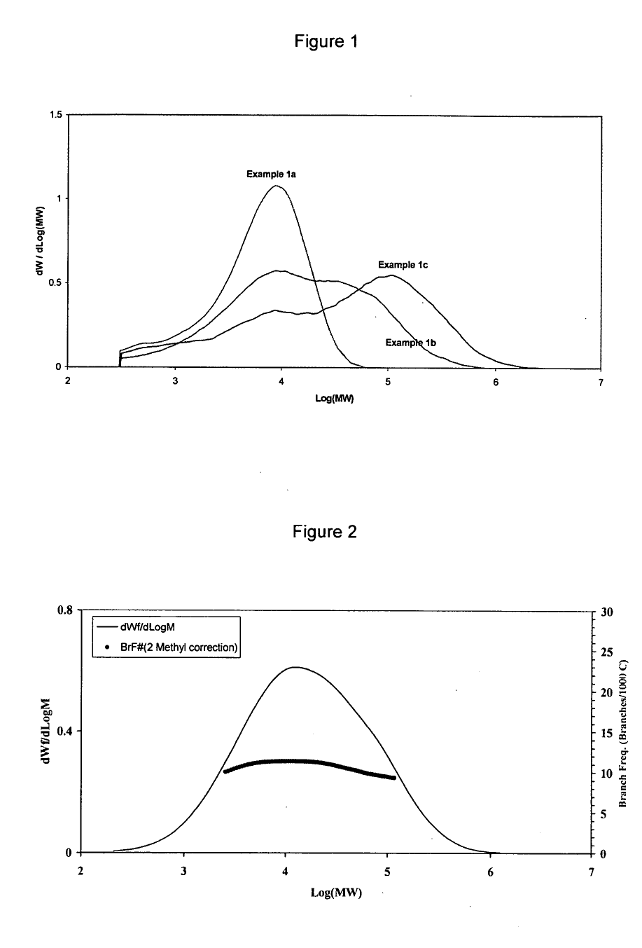

Table 1 and FIG. 1 present the molecular weights and GPC profiles, respectively, of resins produced in Example 1a˜1c. When the polymerization was only 10 minutes long (Example 1a), the consumption of hydrogen was low and hydrogen had not been depleted. As a result, a unimodal resin with low molecular weight and narrow MW distribution was produced. As the polymerization time was prolonged to 30 minutes (Example 1b), hydrogen started to become depleted in the reactor. Hence, a bimodal resin with broader MW distribution was produced, comprising a low MW fraction formed before hydrogen became depleted and a high MW fraction produced after hydrogen became depleted. When the polymerization was extended to 60 minutes (Example 1c), the period in which hydrogen became depleted became longer and hence, the portion of the high MW fraction increases relative to the low MW fraction. Furthermore, as there was less hydrogen remaining in the reactor as the polymerization was prolonged, the MW of the high MW fraction increased, producing a bimodal resin with very broad MW distribution.

### Example 2a

The Parr reactor was heated at 100° C. for 1 hour and thoroughly purged with argon. The reactor was then cooled to 40° C. 910 mL of n-hexane, 30 mL of 1-hexene and 0.6 mL of a 25.5 wt % of triiso-butyl aluminum (TiBAL) in hexanes were added to the reactor. The reactor was then heated to 70° C. Hydrogen from a 150 mL cylinder was added to the reactor such that the pressure drop in the hydrogen cylinder was 10 psia. The reactor was then pressurized with 140 psig ethylene. Argon was used to push 28.7 mg of the supported catalyst prepared above from a tubing into the reactor to start the reaction. During the polymerization, the reactor pressure was maintained constant with 104 psig of ethylene. Throughout the reaction, at intervals of 23.22 L of ethylene consumed, 10 psia of hydrogen from a 150 mL cylinder was quickly added to the reactor. The reaction was carried out for 60 minutes, producing 176.7 g of polymer. The total amount of hydrogen added to the reactor, including the initial charge and additions at intervals, was 50 psia from the 150 mL cylinder.

TABLE 1
Effects of Hydrogen Addition Mode on MW and MW Distribution of Resins

| | | Polymerization | | | | Total H₂ | Polymer | | | | |
|---|---|---|---|---|---|---|---|---|---|---|---|
| | Catalyst | Time | 1-C₆ | H₂ Initially | Additional H₂ | Added | Yield | | | | |
| Example # | (mg) | (minutes) | (mL) | (psia)^{a)} | (psia)^{a)} | (psia)^{a)} | (g) | Mn | Mw | Mz | PD |
| 1a | 26.2 | 10 | 30 | 30 | none | 30 | 25.2 | 3,180 | 8,750 | 14,700 | 2.75 |
| 1b | 27.7 | 30 | 30 | 30 | none | 30 | 61.8 | 4,920 | 37,700 | 134,700 | 7.66 |
| 1c | 28.4 | 60 | 30 | 30 | none | 30 | 108.4 | 5,130 | 105,200 | 385,000 | 20.5 |
| 2a | 28.7 | 60 | 30 | 10 | 10 psia for | 50 | 176.7 | 11,400 | 38,000 | 108,400 | 3.33 |
| | | | | | every 23.2 L of | | | | | | |
| | | | | | C₂ consumed | | | | | | |
| 2b | 26.8 | 60 | 30 | 30 | 30 psia for | 60 | 142.6 | 7,310 | 64,600 | 203,100 | 8.84 |
| | | | | | every 55 L of | | | | | | |
| | | | | | C₂ consumed | | | | | | |

^{a)}Pressure difference of hydrogen from a 150 mL cylinder

### Example 2b

The polymerization was the same as Example 2a, except that 26.8 mg of catalyst was used, 30 psia of hydrogen from the 150 mL cylinder was added initially and an additional 30 psia of hydrogen from the cylinder was added for every 55 L of ethylene consumed. The total amount of hydrogen added was 60 psia from the cylinder. 142.6 g of polymer was produced.

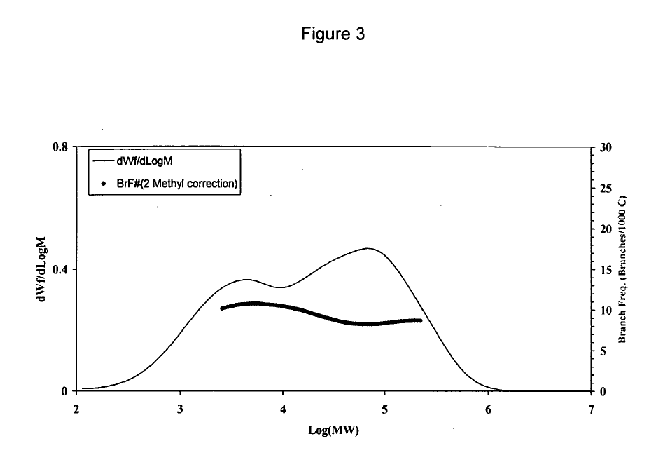

FIGS. 2 and 3 show the comonomer and molecular weight distribution of resins produced in Examples 2a and 2b, respectively. In both examples, the total amounts of hydrogen added into the reactor during the course of polymerization were almost the same (i.e. 50˜60 psia). However, in Example 2a, hydrogen was added at shorter intervals in smaller increment in order to maintain more constant hydrogen level in the reactor. In contrast, in Example 2b, hydrogen was added at longer intervals in larger increment. Hence, in Example 2b, the swing in hydrogen concentration as polymerization proceeded was larger, resulting in a bimodal resin with very broad molecular weight distribution whereas in Example 2a, a unimodal resin with narrower molecular weight distribution was produced. In both examples, the comonomer distribution was relatively uniform with respect to molecular weight. Hence, we have demonstrated that it is feasible to produce a resin with broad to bimodal molecular weight distribution relatively uniform comonomer distribution by cycling the level of hydrogen addition into the reactor.

What is claimed is:

1. A process to produce a copolymer comprising 60 to 99 weight % of ethylene and from 1 to 40 weight % of one or more C₃₋₈ alpha olefins having a Mw/Mn greater than 3 comprising polymerizing a mixture of monomers comprising 60 to 99 weight % of ethylene and from 1 to 40 weight % of one or more C₃₋₈ alpha olefins in the presence of a catalyst comprising a catalyst of the formula: 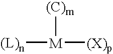
wherein M is a transition metal; C is a bulky heteroatom ligand selected from the group consisting of phosphinimine ligands and ketimide ligands; L is a monoanionic ligand selected from the group consisting of a cyclopentadienyl-type ligand and a bulky heteroatom ligand other than an phosphinimine ligand and a ketimide ligand; X is an activatable ligand; m is 1 or 2; n is 0 or 1; and p is an integer and the sum of m+n+p equals the valence state of M, provided that when m is 2, C may be the same or different bulky heteroatom ligands, and a cocatalyst and cyclically increasing by at least 5% (by pressure) and then decreasing the ratio of hydrogen to ethylene.

2. The process according to claim 1, wherein in the catalyst M is selected from the group consisting of Ti, Zr and Hf.

3. The process according to claim 2, wherein in the catalyst X is selected from the group consisting of a hydrogen atom; a chlorine or fluorine atom; a C₁₋₁₀ hydrocarbyl radical; a C₁₋₁₀ alkoxy radical; a C₅₋₁₀ aryl oxide radical; each of which said hydrocarbyl, alkoxy, and aryl oxide radicals may be unsubstituted by or further substituted by one or more substituents selected from the group consisting of a halogen atom; a C₁₋₈ alkyl radical; a C₁₋₈ alkoxy radical; a C₆₋₁₀ aryl or aryloxy radical; an amido radical which is unsubstituted or substituted by up to two C₁₋₈ alkyl radicals; and a phosphido radical which is unsubstituted or substituted by up to two C₁₋₈ alkyl radicals.

4. The process according to claim 3, wherein in the catalyst L is a cyclopentadienyl-type ligand selected from the group consisting of a cyclopentadienyl radical, an indenyl radical and a fluorenyl radical which are unsubstituted or up to fully substituted by one or more substituents selected from the group consisting of a fluorine atom, a chlorine atom; C₁₋₄ alkyl radicals; and a phenyl or benzyl radical which is unsubstituted or substituted by one or more fluorine or chlorine atoms.

5. The process according to claim 4, wherein the cocatalyst is selected from the group consisting of:
(i) a complex aluminum compound of the formula R¹²₂AlO(R¹²AlO)ₘAlR¹²₂ wherein each R¹² is independently selected from the group consisting of C₁₋₂₀ hydrocarbyl radicals and m is from 3 to 50;
(ii) ionic activators selected from the group consisting of:
(A) compounds of the formula [R¹³]⁺[B(R⁴)₄]⁻ wherein B is a boron atom, R¹³ is a methyl cation which is substituted by three C₅₋₇ aromatic hydrocarbons and each R⁴ is independently selected from the group consisting of phenyl radicals which are unsubstituted or substituted with 3 to 5 substituents selected from the group consisting of a fluorine atom, a C₁₋₄ alkyl or alkoxy radical which is unsubstituted or substituted by a fluorine atom; and a silyl radical of the formula —Si—(R⁵)₃; wherein each R⁵ is independently selected from the group consisting of a hydrogen atom and a C₁₋₄ alkyl radical; and
(B) compounds of the formula [(R⁸)ₜZH]⁺[B(R⁴)₄]⁻ wherein B is a boron atom, H is a hydrogen atom, Z is a nitrogen atom or phosphorus atom, t is 2 or 3 and R⁸ is selected from the group consisting of C₁₋₈ alkyl radicals, a phenyl radical which is unsubstituted or substituted by up to three C₁₋₄ alkyl radicals, or one R⁸ taken together with the nitrogen atom may form an anilinium radical and R⁴ is as defined above; and
(C) compounds of the formula B(R⁴)₃ wherein R⁴ is as defined above; and
(iii) mixtures of (i) and (ii).

6. The process according to claim 5, wherein the cocatalyst is the aluminum compound and is present in an amount to provide a molar ratio of transition metal:Al from the activator from 1:20 to 1:120

7. The process according to claim 5, wherein the activator is an ionic compound and is present in an amount to provide a molar ratio of transition metal to boron from 1:1 to 1:3.

8. The process according to claim 6, wherein in the catalyst n is 1, m is 1, and C is a phosphinimine ligand of the formula [N═P(R³)₃] wherein R³ is selected from the group consisting of C₁₋₁₀ straight chained or branched alkyl radicals, C₆₋₁₀ aryl and aryloxy radicals which are unsubstituted or may be substituted by up to three C₁₋₄ alkyl radicals, and silyl radicals of the formula —Si—(R)₃ wherein R is C₁₋₄ alkyl radical or a phenyl radical.

9. The process according to claim 7, wherein in the catalyst n is 1, m is 1, and C is a phosphinimine ligand of the formula [N═P(R³)₃] wherein R³ is selected from the group consisting of C₁₋₁₀ straight chained or branched alkyl radicals, C₆₋₁₀ aryl and aryloxy radicals which are unsubstituted or may be substituted by up to three C₁₋₄ alkyl radicals, and silyl radicals of the formula —Si—(R)₃ wherein R is C₁₋₄ alkyl radical or a phenyl radical.

10. The process according to claim 6, wherein in the catalyst n is 1, m is 1 and C is a ketimide ligand of the formula: 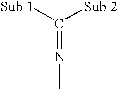
wherein substituents “Sub 1” and “Sub 2” may be the same or different and are selected from the group consisting of hydrocarbyl radicals having from 3 to 6 carbon atoms.

11. The process according to claim 7, wherein in the catalyst n is 1, m is 1 and C is a ketimide ligand of the formula: 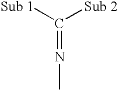
wherein substituents “Sub 1” and “Sub 2” may be the same or different and are selected from the group consisting of hydrocarbyl radicals having from 3 to 6 carbon atoms.

12. The process according to claim 6, wherein in the catalyst n is 0 and m is 2 and C is independently selected from the group consisting of phosphinimine ligands of the formula [N═P(R³)₃] wherein R³ is selected from the group consisting of C₁₋₁₀ straight chained or branched alkyl radicals, C₆₋₁₀ aryl and aryloxy radicals which are unsubstituted or may be substituted by up to three C₁₋₄ alkyl radicals, and silyl radicals of the formula —Si—(R)₃ wherein R is C₁₋₄ alkyl radical or a phenyl radical and ketimide ligands of the formula: 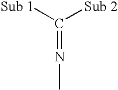
wherein substituents “Sub 1” and “Sub 2” may be the same or different. And are selected from the group consisting of hydrocarbyl radicals having from 3 to 6 carbon atoms.

13. The process according to claim 7, wherein in the catalyst n is 0 and m is 2 and C is independently selected from the group consisting of phosphinimine ligands of the formula [N═P(R³)₃] wherein R³ is selected from the group consisting of C₁₋₁₀ straight chained or branched alkyl radicals, C₆₋₁₀ aryl and aryloxy radicals which are unsubstituted or may be substituted by up to three C₁₋₄ alkyl radicals, and silyl radicals of the formula —Si—(R)₃ wherein R is C₁₋₄ alkyl radical or a phenyl radical and ketimide ligands of the formula: 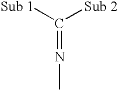
wherein substituents “Sub 1” and “Sub 2” may be the same or different. And are selected from the group consisting of hydrocarbyl radicals having from 3 to 6 carbon atoms.

14. The process according to claim 6, wherein the polymer has a polydispersity from 5 to 25.

15. The process according to claim 14, wherein the cyclical controlled increase of the ratio of hydrogen to ethylene and controlled or uncontrolled decrease of the ratio of hydrogen to ethylene if plotted as a function of time would form a curve selected from the group consisting of sine curves, sharp spike curve, and either a symmetrical or unsymmetrical triangular wave, and a square wave.

16. The process according to claim 15, wherein the ratio of hydrogen to ethylene is increased from 5 up to 500% by pressure over a period of time less than 5 minutes and then the ratio of hydrogen to ethylene declines with the polymerization for a period from 5 to 60 minutes before the next increase.

17. The process according to claim 16, wherein the ratio of hydrogen to ethylene is increased in a period of time of less than 1 minute.

18. The process according to claim 16, wherein the catalyst is on a support selected from the group consisting of alumina, silica and polymeric supports.

19. The process according to claim 18, wherein the support is silica.

20. The process according to claim 19, carried out in gas phase.

21. The process according to claim 19, carried out in slurry phase.

22. The process according to claim 16, carried out in solution phase.

23. The process according to claim 7, wherein the polymer has a polydispersity from 5 to 25.

24. The process according to claim 23, wherein the cyclical controlled increase of the ratio of hydrogen to ethylene and controlled or uncontrolled decrease of the ratio of hydrogen to ethylene if plotted as a function of time would form a curve selected from the group consisting of sine curves, sharp spike curve, and either a symmetrical or unsymmetrical triangular wave, and a square wave.

25. The process according to claim 24, wherein the ratio of hydrogen to ethylene is increased from 5 up to 500% by pressure over a period of time less than 5 minutes and then the ratio of hydrogen to ethylene declines with the polymerization for a period from 5 to 60 minutes before the next increase.

26. The process according to claim 25, wherein the ratio of hydrogen to ethylene is increased in a period of time of less than 1 minute.

27. The process according to claim 25, wherein the catalyst is on a support selected from the group consisting of alumina, silica and polymeric supports.

28. The process according to claim 27, wherein the support is silica.

29. The process according to claim 28, carried out in gas phase.

30. The process according to claim 28, carried out in slurry phase.

31. The process according to claim 25, carried out in solution phase.
